(19) United States
(12) Patent Application Publication
(10) Pub. No.: US 2026/0269498 A1
(43) Pub. Date: Sep. 10, 2026

(54) CONNECTOR ASSEMBLY

(71) Applicant: Japan Aviation Electronics Industry, Ltd., Tokyo (JP)

(72) Inventors: Atsushi Kobayashi, Tokyo (JP); Toshiro Kobuchi, Tokyo (JP); Takashi Omodachi, Irvine, CA (US)

(73) Assignee: Japan Aviation Electronics Industry, Ltd., Tokyo (JP)

(21) Appl. No.: 19/375,901

(22) Filed: Oct. 31, 2025

Related U.S. Application Data
(60) Provisional application No. 63/767,714, filed on Mar. 6, 2025.

(51) Int. Cl. H01R 12/71; H01R 12/70; H01R 12/91

(52) U.S. Cl. CPC H01R 12/716; H01R 12/707; H01R 12/91

(57) ABSTRACT

Each receptacle connector central portion has two reinforcing spring pieces exposed toward an end cavity. A plug connector end portion has two width protection portions capable of facing the two reinforcing spring pieces in a pitch direction in a mated state of the receptacle connector and the plug connector. In a case where the plug connector is relatively moved with respect to the receptacle connector in the pitch direction in the mated state of the receptacle connector and the plug connector, the two width protection portions are respectively received by the two reinforcing spring pieces.

### INCORPORATION BY REFERENCE

This application is based upon and claims the benefit of priority from U.S. Provisional Application 63/767,714, filed on Mar. 6, 2025, the disclosure of which is incorporated herein in its entirety by reference.

### BACKGROUND

The present disclosure relates to a connector assembly.

Patent Document 1 (Japanese Patent Application Publication No. 2015-008055) discloses, as illustrated in FIGS. 12 and 13 of the present application, a connector 102 including a receptacle 100 mounted on a first circuit board and a header 101 mounted on a second circuit board. The receptacle 100 includes a receptacle housing 103. The receptacle housing 103 includes a mating groove portion 104 into which the header 101 is mated. The mating groove portion 104 includes two end portions 104A in the longitudinal direction of the mating groove portion 104 and a central portion 104B in the longitudinal direction of the mating groove portion 104. The two end portions 104A are wider than the central portion 104B.

The header 101 includes a header housing 105. The header housing 105 includes two end portions 105A in the longitudinal direction of the header housing 105 and a central portion 105B in the longitudinal direction of the header housing 105. The two end portions 105A are wider than the central portion 105B.

The two end portions 105A of the header 101 are respectively inserted into the two end portions 104A of the mating groove portion 104. Thus, positioning of the header 101 relative to the receptacle 100 is achieved.

### SUMMARY

In the configuration of Patent Document 1, when an external force in the longitudinal direction acts on the header 101 in a mated state of the header 101 and the receptacle 100, crushing of the receptacle housing 103 of the receptacle 100 and the header housing 105 of the header 101 cannot be avoided.

It is an object of the present disclosure to provide a technique for preventing crushing of the plug connector and the receptacle connector when an external force in the longitudinal direction acts on the plug connector in a mated state of the plug connector and the receptacle connector.

There is provided a connector assembly comprising:
a receptacle connector mountable on a connector mounting surface of a first substrate; and
a plug connector mountable on a connector mounting surface of a second substrate,
   wherein the receptacle connector has a cavity configured to receive the plug connector, the cavity extending in a single row in a pitch direction,
   wherein the cavity comprises:
a central cavity located at a center in the pitch direction; and
an end cavity adjacent to the central cavity in the pitch direction and wider than the central cavity,
   wherein the receptacle connector comprises:
two receptacle connector central portions that partition the central cavity in a width direction orthogonal to the pitch direction; and
a receptacle connector end portion that partitions the end cavity,
   wherein at least one of the two receptacle connector central portions includes a receptacle-side metal member exposed toward the end cavity,
   wherein the plug connector comprises:
a plug connector central portion insertable into the central cavity; and
a plug connector end portion insertable into the end cavity,
   wherein the plug connector end portion includes a plug-side metal member capable of facing the receptacle-side metal member in the pitch direction in a mated state of the receptacle connector and the plug connector, and
   wherein, in a case where the receptacle connector and the plug connector are in the mated state and the plug connector is relatively moved with respect to the receptacle connector in the pitch direction, the plug-side metal member is received by the receptacle-side metal member.

According to the present disclosure, it is possible to prevent crushing of the plug connector and the receptacle connector when an external force in the longitudinal direction acts on the plug connector in a mated state of the plug connector and the receptacle connector.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a connector assembly before mating (First embodiment);

FIG. 2 is a perspective view showing a connector assembly after mating (First embodiment);

FIG. 3 is an exploded perspective view of a receptacle connector (First embodiment);

FIG. 4 is a perspective view of a receptacle hold-down (First embodiment);

FIG. 5 is a schematic plan view of the receptacle connector (First embodiment);

FIG. 6 is a perspective view of a plug connector (First embodiment);

FIG. 7 is an exploded perspective view of the plug connector (First embodiment);

FIG. 8 is a perspective view of a plug hold-down (First embodiment);

FIG. 9 is a perspective view showing the positional relationship of each hold-down in a mated state of the connector assembly (First embodiment);

FIG. 10 is a schematic plan view of the connector assembly in a mated state (First embodiment);

FIG. 11 is a perspective view of a receptacle hold-down (Second embodiment);

FIG. 12 is a view showing a simplified version of FIG. 4 of Patent Document 1; and

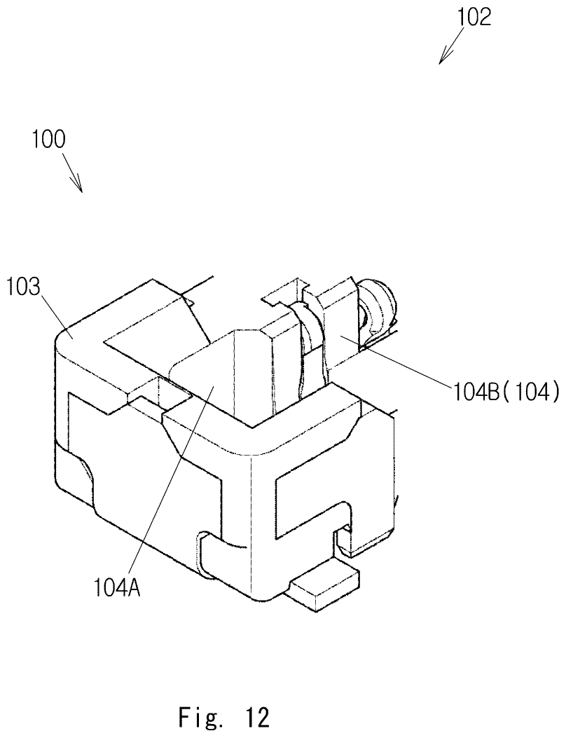

FIG. 13 is a view showing a simplified version of FIG. 8 of Patent Document 1.

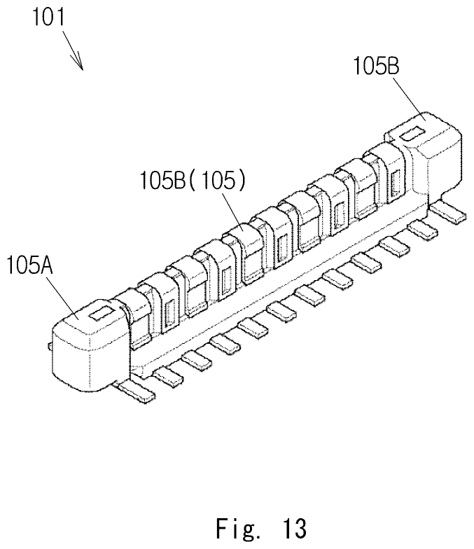

### DESCRIPTION OF EMBODIMENTS

Hereinafter, the present invention will be described through embodiments. However, the invention according to the claims is not limited to the embodiments described below. In addition, not all of the configurations described in the embodiments are necessarily essential as means for solving the problems. For clarity of explanation, the following description and drawings are partially omitted or simplified as appropriate. In the drawings, the same reference numerals are given to the same elements, and redundant explanation is omitted as needed.

In the following embodiments, for convenience of explanation, the description may be divided into a plurality of sections or embodiments when necessary. Unless explicitly stated otherwise, these are not independent of each other, but may be related as modifications, applications, detailed explanations, or supplementary explanations of one another. Further, in the following embodiments, when referring to numerical values such as the number, amount, quantity, or range of components, unless explicitly specified or clearly limited to a specific number in principle, such numbers are not limited to the specified values, and may include values greater or less than the stated ones.

Furthermore, in the following embodiments, unless explicitly stated or clearly considered essential in principle, each component (including operational steps and the like) is not necessarily essential. Likewise, when referring to the shape, positional relationship, or the like of components, unless explicitly stated or clearly considered otherwise in principle, such descriptions shall be construed to include substantially similar or approximate configurations. The same applies to numerical references such as the number, value, quantity, or range.

### First Embodiment

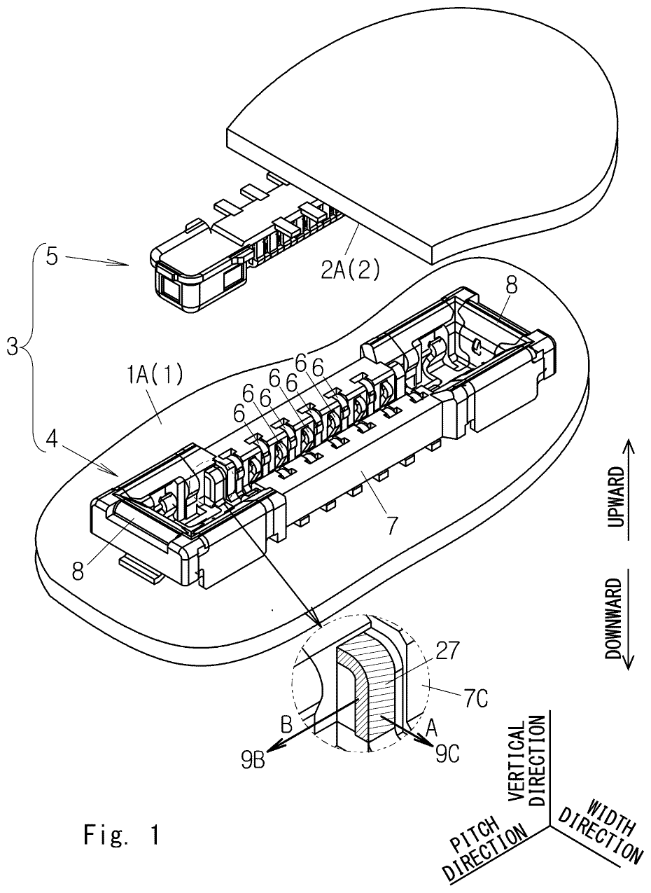

Hereinafter, a first embodiment of the present disclosure will be described with reference to FIGS. 1 to 10.

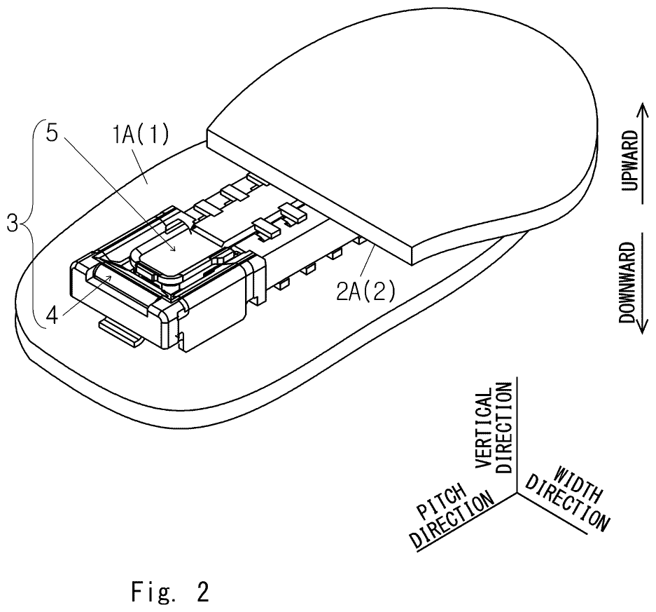

FIGS. 1 and 2 illustrate a connector assembly 3 that mechanically and electrically connects a receptacle-side substrate 1 and a plug-side substrate 2 which are parallel to each other. The receptacle-side substrate 1 is a specific example of the first substrate. The plug-side substrate 2 is a specific example of the second substrate. The connector assembly 3 includes a receptacle connector 4 solder-mounted on a connector mounting surface 1A of the receptacle-side substrate 1, and a plug connector 5 solder-mounted on a connector mounting surface 2A of the plug-side substrate 2.

### Receptacle Connector 4

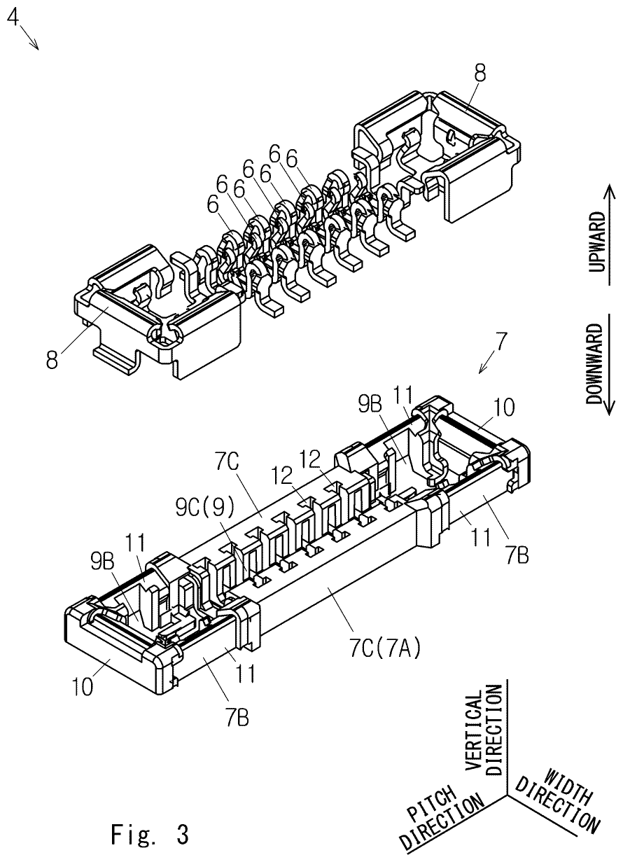

FIG. 3 is an exploded perspective view of the receptacle connector 4. As shown in FIG. 3, the receptacle connector 4 includes a plurality of receptacle contacts 6, a receptacle housing 7 that retains the plurality of receptacle contacts 6, and two receptacle hold-downs 8.

The plurality of receptacle contacts 6 and the two receptacle hold-downs 8 are made of metal and, typically, are formed from a single metal sheet through punching, bending, drawing, cutting, and the like. The receptacle housing 7 is made of an insulating resin and is typically formed by injection molding.

As shown in FIG. 1, the plurality of receptacle contacts 6 are arranged in a single row in a direction parallel to the connector mounting surface 1A of the receptacle-side substrate 1.

Here, with reference to FIG. 1, the “vertical direction,” “pitch direction,” and “width direction” are defined. The vertical, pitch, and width directions are mutually orthogonal.

As shown in FIG. 1, the vertical direction is the direction in which the plug connector 5 is inserted into and removed from the receptacle connector 4. Accordingly, the vertical direction coincides with the height direction of the receptacle connector 4 and also with the height direction of the plug connector 5. The vertical direction includes an upward direction (removal direction) and a downward direction (mating direction). The upward direction is a direction in which the plug connector 5 is removed from the receptacle connector 4. The downward direction is a direction in which the plug connector 5 is mated with the receptacle connector 4. The terms “upward” and “downward” are used merely for convenience of description and do not specify an orientation during use of the connector assembly 3.

The pitch direction is a direction in which the plurality of receptacle contacts 6 are arrayed. The pitch direction includes inward in the pitch direction and outward in the pitch direction. The inward in the pitch direction is a direction approaching the center in the pitch direction of the receptacle connector 4. The outward in the pitch direction is a direction away from the center in the pitch direction of the receptacle connector 4.

The width direction is a direction orthogonal to both the vertical direction and the pitch direction. The width direction includes inward in the width direction and outward in the width direction. The inward in the width direction is a direction approaching the center in the width direction of the receptacle connector 4. The outward in the width direction is a direction away from the center in the width direction of the receptacle connector 4.

As described above, the plurality of receptacle contacts 6 are arranged in a single row in a direction parallel to the connector mounting surface 1A of the receptacle-side substrate 1. Specifically, two receptacle contacts 6 adjacent to each other in the pitch direction among the plurality of receptacle contacts 6 are arranged so as to face in opposite directions. Accordingly, the plurality of receptacle contacts 6 appear to be in a staggered arrangement in plan view. Two receptacle contacts 6 adjacent in the pitch direction among the plurality of receptacle contacts 6 overlap each other when viewed along the pitch direction. The plurality of receptacle contacts 6 overlap each other when viewed along the pitch direction.

As shown in FIG. 3, the receptacle housing 7 is formed to be elongated in the pitch direction. The receptacle housing 7 includes a contact retainer 7A that retains the plurality of receptacle contacts 6, and two hold-down retaining portions 7B that respectively retain the two receptacle hold-downs 8. The contact retainer 7A includes two contact holding portions 7C that face each other in the width direction. The two hold-down retaining portions 7B are disposed so as to sandwich the contact retainer 7A in the pitch direction.

A cavity 9 that receives the plug connector 5 is formed in the receptacle housing 7. The cavity 9 extends in a single row in the pitch direction. The cavity 9 includes a central cavity 9C located at a center in the pitch direction, and two end cavities 9B each adjacent to the central cavity 9C in the pitch direction and wider than the central cavity 9C. Here, that each end cavity 9B is wider than the central cavity 9C means that a dimension in the width direction of the end cavity 9B is greater than a dimension in the width direction of the central cavity 9C. The two contact holding portions 7C are disposed so as to sandwich the central cavity 9C in the width direction. The two hold-down retaining portions 7B are formed in a U-shape opening inward in the pitch direction and are disposed so as to surround the respective end cavities 9B. Each hold-down retaining portion 7B includes a pitch wall portion 10 that partitions the end cavity 9B in the pitch direction, and two width wall portions 11 that partition the end cavity 9B in the width direction. One width wall portion 11, the pitch wall portion 10, and the other width wall portion 11 are continuous in this order so as to form a U-shape opening toward the central cavity 9C.

A plurality of contact retaining grooves 12, each retaining a corresponding one of the plurality of receptacle contacts 6 by press-fitting, are formed in the contact retainer 7A. In plan view, the plurality of contact retaining grooves 12 are arranged in a staggered manner with the central cavity 9C interposed therebetween. Thus, in a state where the plurality of receptacle contacts 6 are retained in the plurality of contact retaining grooves 12, the plurality of receptacle contacts 6 are arranged in a staggered manner. In this state, each receptacle contact 6 is at least partially exposed to the central cavity 9C.

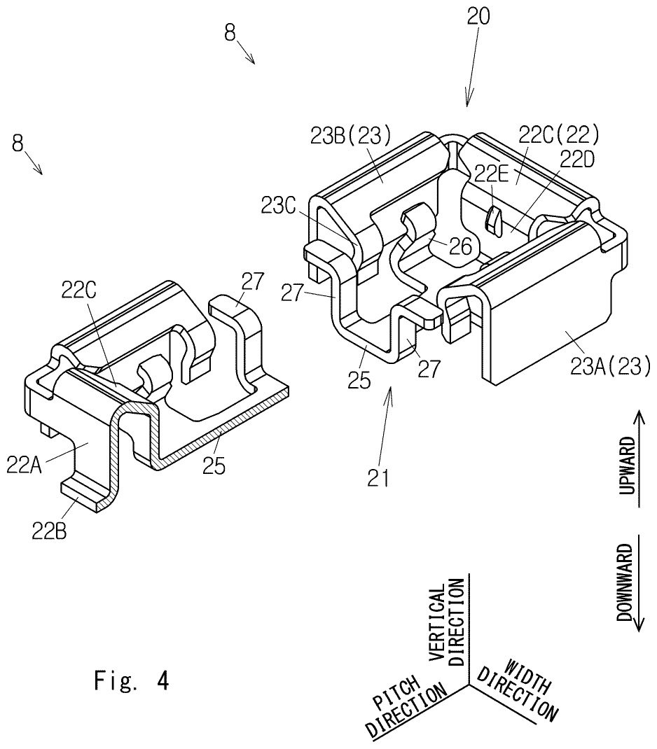

FIG. 4 is a perspective view of the receptacle hold-down 8. In FIG. 4, for convenience of description, one of the two receptacle hold-downs 8 is illustrated as being cut along a cutting plane parallel to the pitch direction. Hereinafter, since the two receptacle hold-downs 8 have the same shape, only one receptacle hold-down 8 will be described and a description of the other is omitted.

The receptacle hold-down 8 is mainly used to fix the receptacle housing 7 to the connector mounting surface 1A of the receptacle-side substrate 1. Each receptacle hold-down 8 includes a hold-down main body 20 and an inner functional portion 21.

The hold-down main body 20 includes a pitch mounting portion 22 to be mounted on the pitch wall portion 10, and two width mounting portions 23 to be mounted on the respective two width wall portions 11. The two width mounting portions 23 are connected to each other via the pitch mounting portion 22.

The pitch mounting portion 22 includes an outer wall 22A disposed outward in the pitch direction of the pitch wall portion 10, a soldering portion 22B that projects downward from the outer wall 22A and is solderable to the connector mounting surface 1A of the receptacle-side substrate 1, a guide portion 22C that extends inward in the pitch direction from an upper end of the outer wall 22A and inclines downward, and an inner wall 22D that projects downward from a distal end of the guide portion 22C. A bulging portion 22E protruding inward in the pitch direction is formed on the inner wall 22D.

Each width mounting portion 23 includes an outer wall 23A disposed outward in the width direction of the width wall portion 11, a guide portion 23B that extends inward in the width direction from an upper end of the outer wall 23A and inclines downward, and a click spring piece 23C that projects downward from a distal end of the guide portion 23B. The click spring piece 23C is curved so as to be convex inward in the width direction.

The inner functional portion 21 includes a connecting portion 25 that extends inward in the pitch direction from a lower end of the inner wall 22D, two contact spring pieces 26 that each extend outward in the width direction and upward from the connecting portion 25, and two reinforcing spring pieces 27 that each extend outward in the width direction and upward from the connecting portion 25 and then extend again outward in the width direction. The two contact spring pieces 26 are disposed farther outward in the pitch direction than the two reinforcing spring pieces 27. The reinforcing spring piece 27 is a specific example of the receptacle-side metal member.

FIG. 1 shows the above-described reinforcing spring pieces 27 in an enlarged view. As shown in FIG. 1, in a state where the two receptacle hold-downs 8 are mounted on the receptacle housing 7, the two reinforcing spring pieces 27 of each receptacle hold-down 8 are respectively disposed at ends of the two contact holding portions 7C outward in the pitch direction, and are exposed inward in the width direction toward the central cavity 9C as indicated by arrow A, and are also exposed outward in the pitch direction toward the end cavities 9B as indicated by arrow B.

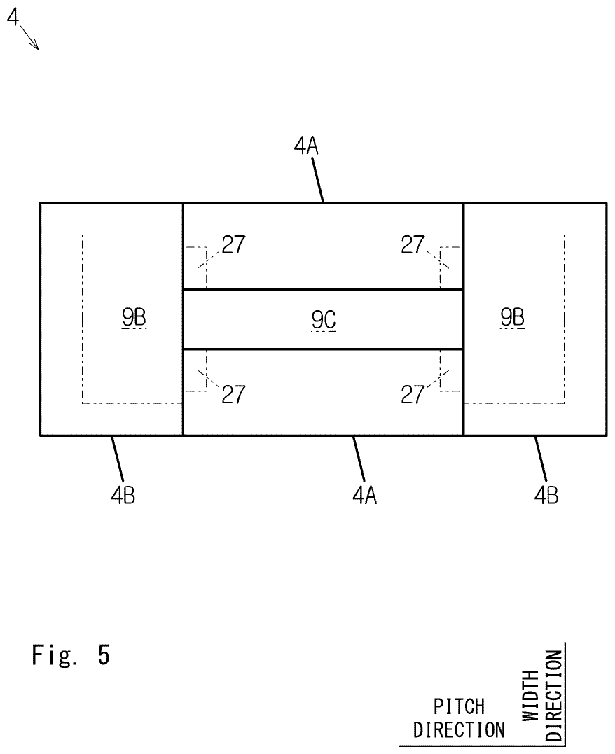

Reference is now made to FIG. 5. FIG. 5 is a schematic plan view of the receptacle connector 4. As shown in FIG. 5, the receptacle connector 4 includes two receptacle connector central portions 4A that partition the central cavity 9C in the width direction, and two receptacle connector end portions 4B that respectively partition the two end cavities 9B. In FIG. 5, the two receptacle connector central portions 4A and the two receptacle connector end portions 4B are depicted in bold lines. Each receptacle connector central portion 4A is constituted mainly by the contact holding portion 7C and the plurality of receptacle contacts 6. Each receptacle connector end portion 4B is constituted mainly by the hold-down retaining portion 7B and the receptacle hold-down 8. The two reinforcing spring pieces 27 of each receptacle hold-down 8 belong to the two receptacle connector central portions 4A, respectively, and are disposed so as to be exposed toward the end cavities 9B.

### Plug Connector 5

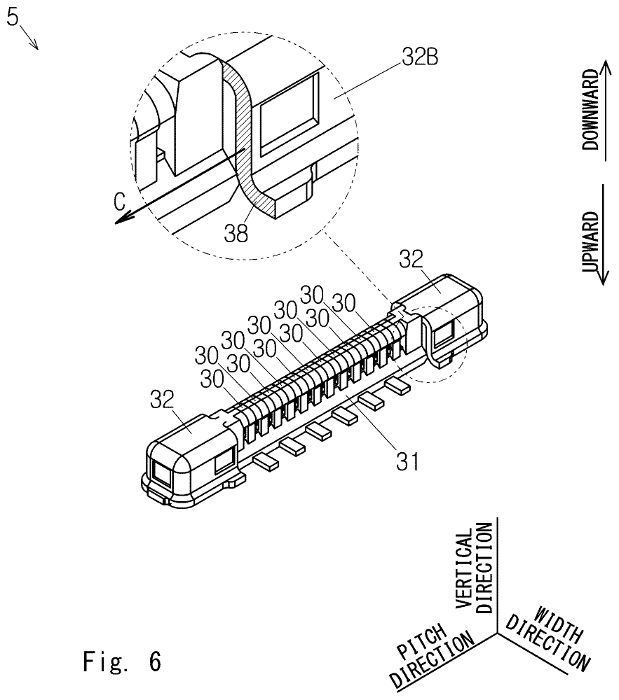

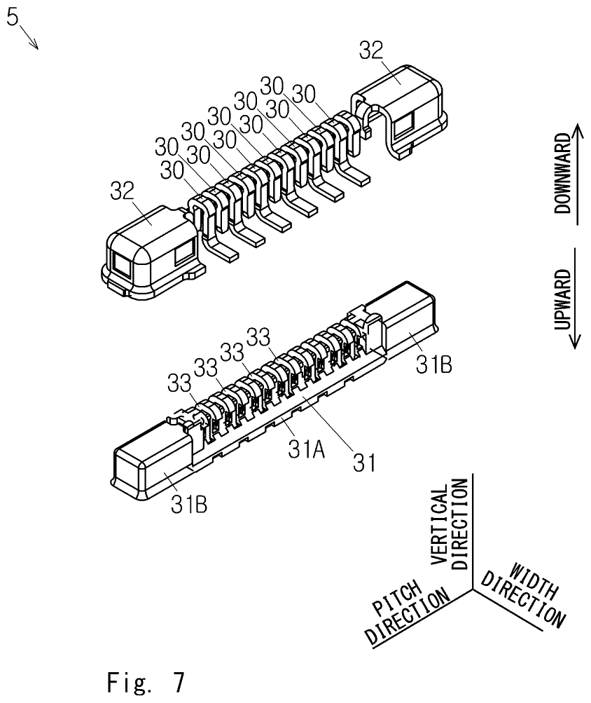

Next, the plug connector 5 will be described with reference to FIGS. 6 to 8. FIG. 6 is a perspective view of the plug connector 5. FIG. 7 is an exploded perspective view of the plug connector 5. Note that, in a mated state in which the plug connector 5 is mated with the receptacle connector 4, an attitude of the plug connector 5 relative to the receptacle connector 4 is uniquely defined. Therefore, in describing the plug connector 5 below, the defined directions described with reference to FIG. 1 are used as they are. For example, in FIG. 6, “upward” and “downward” are depicted upside down.

As shown in FIGS. 5 and 6, the plug connector 5 includes a plurality of plug contacts 30, a plug housing 31 that retains the plurality of plug contacts 30, and two plug hold-downs 32.

The plurality of plug contacts 30 and the two plug hold-downs 32 are made of metal and, typically, are formed from a single metal sheet through punching, bending, drawing, cutting, and the like. The plug housing 31 is made of an insulating resin and is typically formed by injection molding.

As shown in FIG. 7, the plurality of plug contacts 30 are arranged in a single row in a direction parallel to the connector mounting surface 2A of the plug-side substrate 2. Specifically, two plug contacts 30 adjacent to each other in the pitch direction among the plurality of plug contacts 30 are arranged so as to face in opposite directions. Accordingly, the plurality of plug contacts 30 appear to be in a staggered arrangement in plan view. Two plug contacts 30 adjacent in the pitch direction among the plurality of plug contacts 30 overlap each other when viewed along the pitch direction. The plurality of plug contacts 30 overlap each other when viewed along the pitch direction.

As shown in FIG. 7, the plug housing 31 is formed to be elongated in the pitch direction. The plug housing 31 is formed to be insertable into the cavity 9 of the receptacle housing 7. That is, the plug housing 31 has a shape complementary to the cavity 9 of the receptacle housing 7. Accordingly, the plug housing 31 extends in a single row in the pitch direction. The plug housing 31 includes a contact holding portion 31A located at a center in the pitch direction, and two hold-down retaining portions 31B that are adjacent to the contact holding portion 31A in the pitch direction and are wider than the contact holding portion 31A. The two hold-down retaining portions 31B are disposed so as to sandwich the contact holding portion 31A in the pitch direction. The contact holding portion 31A retains the plurality of plug contacts 30. The two hold-down retaining portions 31B respectively retain the two plug hold-downs 32.

A plurality of contact retaining grooves 33, each retaining a corresponding one of the plurality of plug contacts 30 by press-fitting, are formed in the contact holding portion 31A.

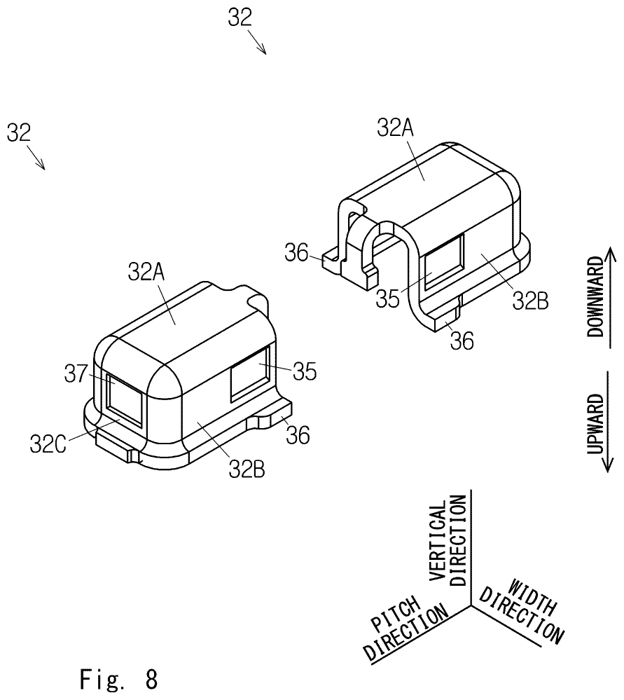

FIG. 8 is a perspective view of the plug hold-down 32. Hereinafter, since the two plug hold-downs 32 have the same shape, only one plug hold-down 32 will be described and a description of the other is omitted.

The plug hold-down 32 is mainly used to fix the plug housing 31 to the connector mounting surface 2A of the plug-side substrate 2.

The plug hold-down 32 includes an upper protection portion 32A that covers the hold-down retaining portion 31B in the vertical direction, two width protection portions 32B that cover the hold-down retaining portion 31B in the width direction, and a pitch protection portion 32C that covers the hold-down retaining portion 31B in the pitch direction. Each width protection portion 32B is a specific example of the plug-side metal member.

The upper protection portion 32A, the two width protection portions 32B, and the pitch protection portion 32C are connected to each other. That is, the two width protection portions 32B extend upward from respective ends in the width direction of the upper protection portion 32A. The pitch protection portion 32C extends upward from an end in the pitch direction of the upper protection portion 32A.

A click recess 35 is formed in each width protection portion 32B. A soldering portion 36 solderable to the connector mounting surface 2A of the plug-side substrate 2 is formed so as to extend outward in the width direction from each width protection portion 32B. A click recess 37 is formed in the pitch protection portion 32C.

FIG. 6 shows the width protection portion 32B of the plug hold-down 32 in an enlarged view. As shown in FIG. 6, in a state where the two plug hold-downs 32 are mounted on the plug housing 31, the two width protection portions 32B of each plug hold-down 32 are disposed outward in the width direction of the hold-down retaining portion 31B of the plug housing 31 and are exposed inward in the pitch direction as indicated by arrow C. Specifically, each width protection portion 32B has a pitch restricting surface 38 that faces inward in the width direction. In FIG. 6, the pitch restricting surface 38 is emphasized by hatching.

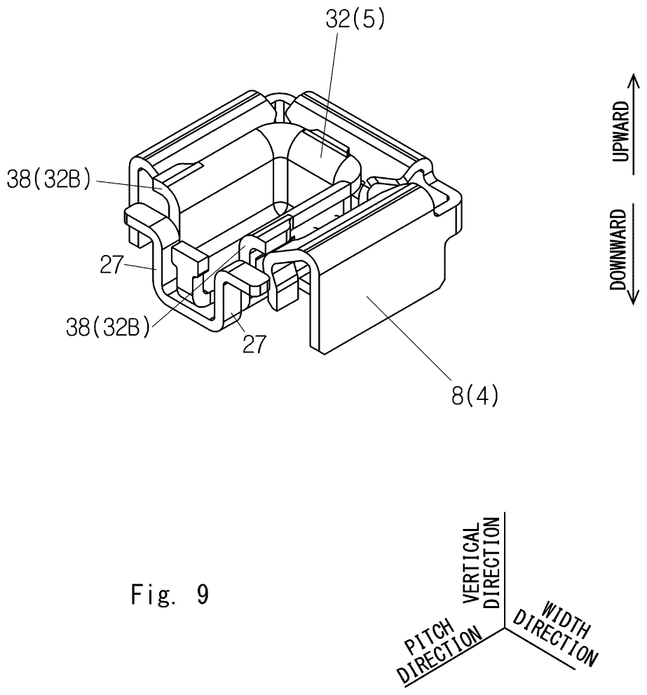

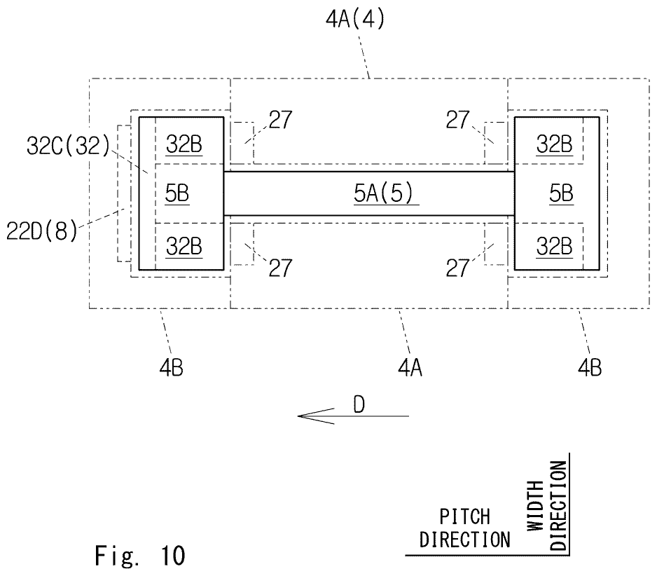

Next, with reference to FIGS. 1, 2, 9, and 10, the operation of the connector assembly 3 will be described. FIG. 9 is a perspective view showing a positional relationship between the receptacle hold-down 8 and the plug hold-down 32 in a mated state of the connector assembly 3. FIG. 10 is a schematic plan view of the connector assembly 3 in the mated state.

First, as shown in FIG. 1, the receptacle connector 4 is solder-mounted on the connector mounting surface 1A of the receptacle-side substrate 1, and the plug connector 5 is solder-mounted on the connector mounting surface 2A of the plug-side substrate 2.

Next, as shown in FIGS. 1 and 2, the plug connector 5 is relatively lowered with respect to the receptacle connector 4, and the plug connector 5 is inserted into the cavity 9 of the receptacle connector 4. Thereby, the plug connector 5 is mated with the receptacle connector 4. In the mated state of the connector assembly 3, the plurality of receptacle contacts 6 of the receptacle connector 4 and the plurality of plug contacts 30 of the plug connector 5 are in electrical contact with each other, respectively.

When the plug connector 5 is inserted into the cavity 9 of the receptacle connector 4, tactile feedback is provided to the user to indicate that the plug connector 5 has been mated with the receptacle connector 4.

Specifically, when the plug connector 5 is inserted into the cavity 9 of the receptacle connector 4, at a timing when the two click spring pieces 23C of each receptacle hold-down 8 of the receptacle connector 4 shown in FIG. 4 fit into the two click recesses 35 of each plug hold-down 32 of the plug connector 5 shown in FIG. 8, a pressing force required for inserting the plug connector 5 into the cavity 9 of the receptacle connector 4 is sharply reduced. Similarly, when the plug connector 5 is inserted into the cavity 9 of the receptacle connector 4, at a timing when the bulging portion 22E of each receptacle hold-down 8 of the receptacle connector 4 shown in FIG. 4 fits into the click recess 37 of each plug hold-down 32 of the plug connector 5 shown in FIG. 8, the pressing force required for inserting the plug connector 5 into the cavity 9 of the receptacle connector 4 is sharply reduced. Such a sharp reduction in the pressing force provides the user with tactile feedback that indicates that the plug connector 5 has been mated with the receptacle connector 4.

The tactile feedback indicating that the plug connector 5 has been mated with the receptacle connector 4 provides an effect of increasing a removal force required for removing the plug connector 5 from the receptacle connector 4.

In the mated state of the connector assembly 3, the two contact spring pieces 26 of each receptacle hold-down 8 of the receptacle connector 4 shown in FIG. 4 elastically contact the two width protection portions 32B of each plug hold-down 32 of the plug connector 5 shown in FIG. 8 by spring restoring force, respectively. Thus, the two receptacle hold-downs 8 of the receptacle connector 4 are electrically connected to the two plug hold-downs 32 of the plug connector 5, respectively. That is, the two receptacle hold-downs 8 of the receptacle connector 4 and the two plug hold-downs 32 of the plug connector 5 can typically function as contacts for power supply by being electrically connected to each other.

FIG. 9 shows a positional relationship of each hold-down in the mated state of the connector assembly 3. As shown in FIG. 9, in the mated state of the connector assembly 3, the pitch restricting surfaces 38 of the two width protection portions 32B of each plug hold-down 32 of the plug connector 5 face the two reinforcing spring pieces 27 of each receptacle hold-down 8 of the receptacle connector 4 in the pitch direction, respectively. The opposing relationship will be schematically described below with reference to FIG. 10.

FIG. 10 schematically shows, similarly to FIG. 5, a plan view of the connector assembly 3 in the mated state. As shown in FIG. 10, the plug connector 5 includes a plug connector central portion 5A insertable into the central cavity 9C, and two plug connector end portions 5B respectively insertable into the two end cavities 9B. In FIG. 10, the plug connector central portion 5A and the two plug connector end portions 5B are depicted in bold lines. The plug connector central portion 5A is constituted mainly by the contact holding portion 31A of the plug housing 31 and the plurality of plug contacts 30. Each plug connector end portion 5B is constituted mainly by the hold-down retaining portion 31B of the plug housing 31 and the plug hold-down 32. The two plug connector end portions 5B are disposed so as to be adjacent to the plug connector central portion 5A in the pitch direction. The two plug connector end portions 5B are disposed so as to sandwich the plug connector central portion 5A in the pitch direction. The two plug connector end portions 5B are configured to be wider than the plug connector central portion 5A. Each plug connector end portion 5B has two width protection portions 32B capable of facing, in the pitch direction in the mated state of the connector assembly 3, the two reinforcing spring pieces 27, respectively.

When the plug connector 5 is relatively moved with respect to the receptacle connector 4 in the pitch direction as indicated by arrow D in FIG. 10, the plug connector 5 is received by the receptacle connector 4 at different positions in the pitch direction.

Specifically, when the plug connector 5 is relatively moved with respect to the receptacle connector 4 in the pitch direction as indicated by arrow D, on the left side of the drawing in FIG. 10, the left plug connector end portion 5B of the plug connector 5 is received by the left receptacle connector end portion 4B of the receptacle connector 4. More specifically, the pitch protection portion 32C of the left plug hold-down 32 of the plug connector 5 is received by the inner wall 22D of the left receptacle hold-down 8 of the receptacle connector 4.

Further, when the plug connector 5 is relatively moved with respect to the receptacle connector 4 in the pitch direction as indicated by arrow D, on the right side of the drawing in FIG. 10, the right plug connector end portion 5B of the plug connector 5 is received by the two receptacle connector central portions 4A of the receptacle connector 4. More specifically, the two width protection portions 32B of the right plug hold-down 32 of the plug connector 5 are received by the two reinforcing spring pieces 27 of the right receptacle hold-down 8 of the receptacle connector 4, respectively.

Thus, when the plug connector 5 is relatively moved in the pitch direction with respect to the receptacle connector 4, in addition to being received by the left receptacle connector end portion 4B of the receptacle connector 4 on the left side of the drawing in FIG. 10, the plug connector 5 is received by the two receptacle connector central portions 4A of the receptacle connector 4 on the right side of the drawing in FIG. 10. Accordingly, as compared with a case where the plug connector 5 is not received by the two receptacle connector central portions 4A of the receptacle connector 4 on the right side of the drawing in FIG. 10, buckling deformation of the plug housing 31 of the plug connector 5 can be prevented when an external force in the direction indicated by arrow D acts on the plug connector 5.

In this embodiment, as described above, when the plug connector 5 is relatively moved in the pitch direction with respect to the receptacle connector 4, in addition to being received by the left receptacle connector end portion 4B of the receptacle connector 4 on the left side of the drawing in FIG. 10, the plug connector 5 is received by the two receptacle connector central portions 4A of the receptacle connector 4 on the right side of the drawing in FIG. 10. However, when the plug connector 5 is relatively moved in the pitch direction with respect to the receptacle connector 4, reception by the left receptacle connector end portion 4B on the left side of the drawing in FIG. 10 may be omitted. Even in this case, buckling deformation of the plug housing 31 of the plug connector 5 can similarly be prevented.

In this embodiment, as described above, when the plug connector 5 is relatively moved in the pitch direction with respect to the receptacle connector 4, the two metal width protection portions 32B of the right plug hold-down 32 of the plug connector 5 are received by the two metal reinforcing spring pieces 27 of the right receptacle hold-down 8 of the receptacle connector 4. In short, when the plug connector 5 is relatively moved in the pitch direction with respect to the receptacle connector 4, on the right side of the drawing in FIG. 10, the plug connector 5 is received by the receptacle connector 4 through metal-to-metal contact between the plug connector 5 and the receptacle connector 4. Accordingly, as compared with a case where the right hold-down retaining portion 31B of the plug connector 5 is received by the two contact holding portions 7C of the receptacle connector 4 when the plug connector 5 is relatively moved in the pitch direction with respect to the receptacle connector 4, crushing of the receptacle connector 4 and the plug connector 5 can be effectively prevented.

### Second Embodiment

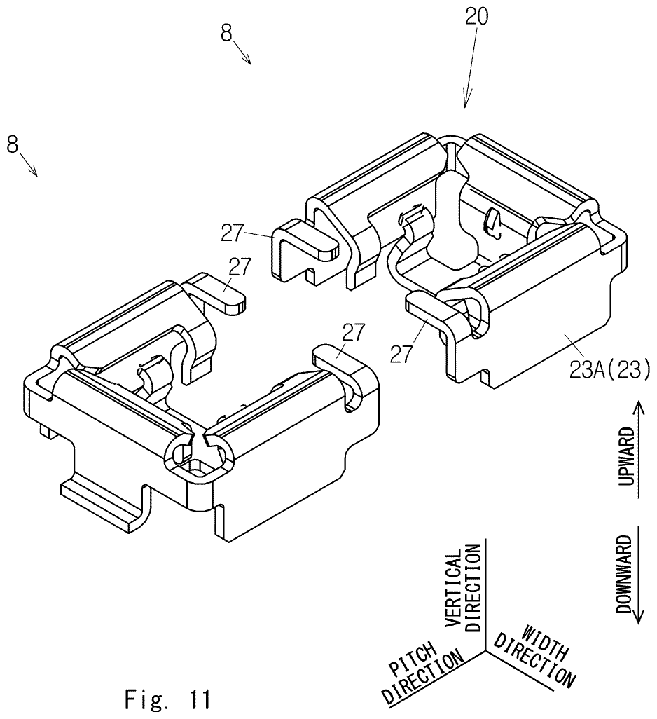

Next, a second embodiment of the present disclosure will be described with reference to FIG. 11. Hereinafter, differences from the first embodiment described above will be mainly described and overlapping descriptions are omitted.

In this embodiment, as compared with the first embodiment, the shape of the receptacle hold-down 8 is different. That is, as shown in FIG. 4, in the first embodiment, the two reinforcing spring pieces 27 are supported by the connecting portion 25.

In contrast, in this embodiment, as shown in FIG. 11, the two reinforcing spring pieces 27 are supported by the outer walls 23A of the two width mounting portions 23, respectively. Specifically, each reinforcing spring piece 27 is formed in an L-shape so as to protrude inward in the pitch direction and inward in the width direction from a corresponding outer wall 23A. In this manner, how the two reinforcing spring pieces 27 are constructed in the receptacle hold-down 8 is not limited.

The first and second embodiments of the present disclosure have been described above. The first and second embodiments have the following features.

The connector assembly 3 includes the receptacle connector 4 mountable on the connector mounting surface 1A of the receptacle-side substrate 1 (first substrate), and the plug connector 5 mountable on the connector mounting surface 2A of the plug-side substrate 2 (second substrate). A cavity 9 configured to receive the plug connector 5 and extending in a single row in the pitch direction is formed in the receptacle connector 4. The cavity 9 includes the central cavity 9C located at the center in the pitch direction, and the two end cavities 9B each adjacent to the central cavity 9C in the pitch direction and wider than the central cavity 9C. The receptacle connector 4 includes the two receptacle connector central portions 4A that partition the central cavity 9C in the width direction orthogonal to the pitch direction, and the two receptacle connector end portions 4B that respectively partition the two end cavities 9B. Each receptacle connector central portion 4A has two reinforcing spring pieces 27 (receptacle-side metal members) exposed toward one end cavity 9B and two reinforcing spring pieces 27 exposed toward the other end cavity 9B. The plug connector 5 includes the plug connector central portion 5A insertable into the central cavity 9C, and the two plug connector end portions 5B respectively insertable into the two end cavities 9B. One plug connector end portion 5B has the two width protection portions 32B (plug-side metal members) capable of facing, in the pitch direction in a mated state of the receptacle connector 4 and the plug connector 5, the two reinforcing spring pieces 27, respectively. The other plug connector end portion 5B is similarly configured. In a case where the receptacle connector 4 and the plug connector 5 are in the mated state and the plug connector 5 is relatively moved with respect to the receptacle connector 4 in the pitch direction, the two width protection portions 32B are received by the two reinforcing spring pieces 27, respectively. According to the above configuration, it is possible to prevent crushing of the plug connector 5 and the receptacle connector 4 when an external force in the pitch direction acts on the plug connector 5 in the mated state of the plug connector 5 and the receptacle connector 4.

In Patent Document 1 described above, a wide portion is provided to the plug mainly for the purpose of positioning. Accordingly, Patent Document 1 provides no motivation to modify the configuration so that an external force in the pitch direction acting on the plug is received through metal-to-metal contact. Furthermore, if the configuration were modified in Patent Document 1 so that an external force in the pitch direction acting on the plug is received through metal-to-metal contact, an increased number of components would deteriorate positioning accuracy in Patent Document 1. In this sense as well, Patent Document 1 cannot be modified so that an external force in the pitch direction acting on the plug is received through metal-to-metal contact.

Although the present invention has been described with reference to a plurality of embodiments, the present invention is not limited thereto. Various changes to the configuration and details of the present invention can be made within the scope of the invention as understood by those skilled in the art.

For example, in the first and second embodiments described above, the two reinforcing spring pieces 27 are configured as part of the receptacle hold-down 8. This makes it possible to realize the receptacle connector 4 with a small number of components and thus contributes to cost reduction of the receptacle connector 4. However, the present invention is not limited thereto, and the two reinforcing spring pieces 27 may be configured as components separate from the receptacle hold-down 8. Similarly, the two width protection portions 32B are configured as part of the plug hold-down 32. This makes it possible to realize the plug connector 5 with a small number of components and thus contributes to cost reduction of the plug connector 5. However, the present invention is not limited thereto, and the two width protection portions 32B may be configured as components separate from the plug hold-down 32.

In the first and second embodiments described above, one of the two reinforcing spring pieces 27 of each receptacle hold-down 8 may be omitted. Similarly, one of the two width protection portions 32B of each plug hold-down 32 may be omitted. Even in this case, when an external force in the pitch direction acts on the plug connector 5 in the mated state of the plug connector 5 and the receptacle connector 4, the external force is received through metal-to-metal contact.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector assembly comprising:
a receptacle connector mountable on a connector mounting surface of a first substrate; and
a plug connector mountable on a connector mounting surface of a second substrate,
wherein the receptacle connector has a cavity configured to receive the plug connector, the cavity extending in a single row in a pitch direction,
wherein the cavity comprises:
a central cavity located at a center in the pitch direction; and
an end cavity adjacent to the central cavity in the pitch direction and wider than the central cavity,
wherein the receptacle connector comprises:
two receptacle connector central portions that partition the central cavity in a width direction orthogonal to the pitch direction; and
a receptacle connector end portion that partitions the end cavity,
wherein at least one of the two receptacle connector central portions includes a receptacle-side metal member exposed toward the end cavity,
wherein the plug connector comprises:
a plug connector central portion insertable into the central cavity; and
a plug connector end portion insertable into the end cavity,
wherein the plug connector end portion includes a plug-side metal member capable of facing the receptacle-side metal member in the pitch direction in a mated state of the receptacle connector and the plug connector, and
wherein, in a case where the receptacle connector and the plug connector are in the mated state and the plug connector is relatively moved with respect to the receptacle connector in the pitch direction, the plug-side metal member is received by the receptacle-side metal member.

2. The connector assembly according to claim 1,
wherein the receptacle connector further comprises a receptacle-side hold-down, and
wherein the receptacle-side metal member is configured as part of the receptacle-side hold-down.

3. The connector assembly according to claim 2,
wherein the receptacle-side hold-down includes a soldering portion that is solderable to the connector mounting surface of the first substrate.

4. The connector assembly according to claim 1,
wherein the plug connector further comprises a plug-side hold-down, and
wherein the plug-side metal member is configured as part of the plug-side hold-down.

5. The connector assembly according to claim 4,
wherein the plug-side hold-down includes a soldering portion that is solderable to the connector mounting surface of the second substrate.
